(19) United States
(12) Patent Application Publication
(10) Pub. No.: US 2026/0273863 A1
(43) Pub. Date: Sep. 17, 2026

(54) 3D CONCRETE PRINTING QUALITY MONITORING AND CONTROL SYSTEM AND METHOD

(71) Applicant: Applied Research Transformation, PLLC, Research Triangle Park, NC (US)

(72) Inventors: Rakesh Anthony Khan, Wake Forest, NC (US); Ladson Montgomery Brearley, Cary, NC (US)

(21) Appl. No.: 19/533,466

(22) Filed: Feb. 9, 2026

Related U.S. Application Data
(63) Continuation of application No. PCT/US24/41642, filed on Aug. 9, 2024.
(60) Provisional application No. 63/518,430, filed on Aug. 9, 2023.

(51) Int. Cl. B29C 64/393; B28B 17/00; B29C 64/106; B33Y 50/02

(52) U.S. Cl. CPC B29C 64/393; B28B 17/0072; B29C 64/106; B33Y 50/02

(57) ABSTRACT

A 3D concrete printing quality monitoring and control system, for use with a 3D concrete printer having a printing head terminating in a nozzle with an aperture configured to direct application of concrete, includes a camera assembly having one or more cameras sensitive to a specific wavelength range, having a field of view of a concrete layer surface, and configured to capture image data from the concrete layer surface. The system further includes a computing device in communication with the camera assembly that has a communication module to receive image data, memory units storing image analysis instructions and algorithmic instructions, and a processing unit that generates one or more surface condition parameters from image data based on image analysis instructions and generates an analyzed result (e.g. setting progress and predicted interlayer bond strength) based on one or more surface condition parameters as a result of the algorithmic instructions.

### CROSS-REFERENCE TO RELATED APPLICATIONS

This application is a continuation of PCT Patent Application No. PCT/US2024/041642, which was filed on Aug. 9, 2024, which claims priority to U.S. Provisional Patent Application No. 63/518,430, which was filed on Aug. 9, 2023, the entire contents of each of which are hereby incorporated by reference in their entireties.

### TECHNICAL FIELD

The present disclosure relates to systems and methods for 3D concrete printing quality monitoring and control. More particularly, the present disclosure relates to systems and methods which monitor and control the quality of 3D concrete printing which accounts for environmental factors through the capture and use of image data of surfaces of concrete, such as a surface on which concrete will be printed.

### BACKGROUND

With the rise in popularity and usefulness of 3D printing processes, new additive manufacturing processes have been developed for other materials. Indeed, since the first proof of concept projects involving concrete in an additive process, there has been much research into approaches, devices, and methods surrounding 3D concrete printing (3DCP). These research efforts are driven by potentially large economic and environmental benefits. Indeed, use of 3DCP usually involves the absence of formwork, minimized labor requirements, faster construction, and low environmental impacts.

While research into 3DCP has made substantial developments and discoveries, most of those have been in controlled environments, like laboratories and factories. However, structures prepared using 3DCP are generally heavy and unable to be easily transported. Therefore, a great number of the uses for any 3DCP system and projects will be in the field, in generally uncontrolled environments. In the field, there are many uncontrollable environmental factors, such as temperature, sun exposure, wind, humidity, and dust, which are not generally present in a controlled factory or lab.

A critical aspect to any 3DCP system and job is the interlayer bond strength, the ability of each printed concrete layer to adhere to a previous layer. The interlayer bond strength is particularly critical to the structural capacity of structures, like walls, and can significantly influence mechanical and durability properties of printed structures in different environments. The interlayer bond strength is influenced by many factors, including the cementitious mix properties, mixing process, rate of placement, curing method, and plastic shrinkage. Additionally, the interlayer bond strength is also affected by environmental factors. Further important aspects that can be critical to any 3DCP job and which are also affected by factors, including those mentioned above, are concrete setting progress, surface roughness, and concrete bead quality.

Currently, the methodology related to 3DCP involves conservative, tight control conditions related to the water-cement ratio and time. Having conditions fall outside of the tight controls, particularly those related to time, can mean, at best, taking additional steps to help those layers bond and, at worst, failure of a project entirely.

However, these tight controls do not contemplate all factors which impact critical 3DCP aspects, such as concrete setting progress, surface roughness, concrete bead quality, and interlayer bond strength, particularly environmental factors. Moreover, these tight controls do not provide an informed and effective quality monitoring and control system that can give accurate and timely information about a job based on a current printing job. Indeed, the ideal time between printing of layers is variable based on the environmental factors but could be determined if concrete setting progress was known and monitored. Moreover, an effective quality monitoring and control system can help facilitate future regulations, which are still unsettled, toward better fitting controls that are not needlessly conservative.

Therefore, there is a need for a quality monitoring and control system that can provide consistency to 3DCP projects, provide informed and effective information for 3D concrete printing, like concrete setting progress, surface roughness, concrete bead quality, and interlayer bond strength, that account for environmental factors and provides a better guide for parameters related to the printing of each concrete layer.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In view of the above, one purpose of the present quality monitoring and control system is to provide informed and effective information for 3DCP, like concrete setting progress, surface roughness, concrete bead quality, and interlayer bond strength, that account for environmental factors and provide a better guide for determining the parameters related to the concrete printing process, in various aspects.

According to several embodiments, a 3DCP quality monitoring and control system for use with a 3D concrete printer having a printing head terminating in a nozzle with an aperture configured to direct application of concrete includes a camera assembly having one or more cameras configured to be sensitive to at least one specific wavelength range and having a field of view including at least a portion of a concrete layer surface and the one or more cameras are configured to capture image data from the concrete layer surface. In embodiments, the quality monitoring and control system includes a computing device, in communication with the camera assembly, having a communication module configured to receive the image data transmitted by the camera assembly, one or more memory units configured to store image data and containing instructions that include, at least, image analysis instructions and algorithmic instructions, and a processing unit configured to utilize the image analysis instructions to generate one or more surface condition parameters from stored image data and to utilize the algorithmic instructions to generate an analyzed result based at least on the one or more surface condition parameters.

In embodiments, the camera assembly comprises a mount affixed to and supporting the one or more cameras and the field of view of the one or more cameras is independent relative to movement of the nozzle. In certain embodiments thereof, the mount and the field of view of the one or more cameras are both stationary. In other embodiments thereof, at least one of the mounts and the field of view of one or more of the cameras is movable. In specific embodiments, at least one of the mounts and the one or more cameras is configured to move based on at least one of direct manipulation by a user and motorized manipulation based on user commands or programmed to be automatic, such as by elevating a camera automatically to maintain a set distance apart.

In additional embodiments, the one or more cameras comprise at least one camera affixed to the printing head of the 3D concrete printer and configured to capture image data from the concrete layer surface adjacent to the nozzle of the 3D concrete printer. Indeed, the one or more cameras comprise two cameras affixed to the printing head on opposed sides in particular embodiments. In certain embodiments, the one or more cameras comprise multiple cameras disposed radially around the printing head. In a specific embodiment thereof, the processing unit is configured to combine image data captured by each of the multiple cameras into one or more stitched images of the concrete layer surface based on the image analysis instructions.

In various embodiments, the processing unit is configured to standardize the image data prior to generating the one or more surface condition parameters.

In further embodiments, the camera assembly further comprises an illumination source. In certain embodiments thereof, the processing unit is configured to standardize the image data, prior to generating the one or more surface condition parameters, based on a comparison of a first set of image data collected when the illumination source is inactive and a second set of image data collected when the illumination source is active.

In particular embodiments, the system further comprises a reference member disposed within the field of view of the one or more cameras and the processing unit is configured to standardize the image data, prior to generating the one or more surface condition parameters, based on image data of the reference member.

In additional embodiments, the camera assembly further comprises an optical manipulation device comprising a filter disposed adjacent to a camera lens of one of the one or more cameras.

In further embodiments, the camera assembly further comprises an optical manipulation device comprising a spectrograph disposed adjacent to or integrated with a camera of the one or more cameras and wherein the spectrograph is configured to produce multiple component wavelengths comprising at least one specific range the camera with a spectrograph is sensitive to.

In more embodiments, the analyzed result, generated by the processing unit based on the algorithmic instructions, comprises at least one value indicative of one of concrete setting progress, surface roughness, concrete bead quality, and interlayer bond strength.

In embodiments, the system further comprises an input device configured to capture or receive additional data comprising at least one of environmental condition data and concrete mixture data, the communication module is further configured to receive the additional data transmitted by the input device, the one or more memory units are further configured to store the additional data, and the processing unit is configured to utilize the algorithmic instructions to generate an analyzed result based on the additional data and the one or more surface condition parameters. In specific embodiments thereof, the additional data comprises environmental condition data and the input device comprises one or more sensors designed to sense one or more of temperature, sun exposure, wind, humidity, and dust. In certain embodiments thereof, the additional data comprises concrete mixture data and the input device comprises one or more sensors designed to sense one or more of viscosity, rheology, temperature, weight, moisture, and resistivity. In further embodiments thereof, the input device is configured to accept user input.

In various embodiments, the one or more cameras comprise a camera utilizing a sensor based on colloidal quantum dot thin film photodiodes fabricated monolithically on silicon readout wafers.

In certain embodiments, the one or more cameras comprise a camera utilizing indium gallium arsenide sensors.

In additional embodiments, the at least one specific wavelength range comprises a first subset range narrower than and within the range of 800 nm to 3000 nm.

Moreover, the at least one specific wavelength range comprises a first subset range narrower than and within the range of 300 nm to 3000 nm in further embodiments. Indeed, in at least one embodiment, the at least one specific wavelength range further comprises a second subset range also between 300 nm to 3000 nm but not overlapping with the first subset range.

In further embodiments, the camera assembly is in wireless communication with the computing device. In alternative embodiments, the camera assembly is in wired communication with the computing device.

In additional embodiments, the analyzed result is transmitted to a user device operatively connected to the computing device. In specific embodiments thereof, the user device is configured to display the analyzed result to a user, and the user device is configured to accept input from the user utilized to adjust a controller operatively connected to the 3D concrete printer based on the analyzed result.

In various embodiments, the analyzed result is transmitted to a controller operatively connected to the 3D concrete printer. In specific embodiments thereof, the controller is configured to utilize the analyzed result to adjust at least one parameter or setting associated with the 3D concrete printer. In other embodiments thereof, the controller is configured to receive location data regarding the nozzle from one or more sensors and transmit the location data to the computing device and wherein the computing device is configured to pair the location data with the imaging data and store the location data in the one or more memory units. In certain embodiments thereof, the controller is also operatively connected to an adaptive batching device in fluid communication with the 3D concrete printing head and configured to adjust ingredients of concrete to be printed or to apply ingredients directly on the concrete surface layer.

In further embodiments, the one or more memory units also store additional data, comprising at least one of environmental condition data and concrete mixture data. In various embodiments thereof, the processing unit is configured to produce the analyzed result based on the additional data and the one or more surface condition parameters. In still more specific embodiments, the additional data is either adjustable or replaceable based on input data received from an input device or a 3D concrete printer in communication with the computing device. Indeed, the 3D concrete printer itself or a separate input device may comprise one or more sensors designed to sense one or more of a mix temperature, pressure associated with the application of concrete through the nozzle, a ratio of water and cement, and resistivity and, if available, would communicate that information to the computing device, in further specific embodiments.

In aspects, a 3DCP quality monitoring and control method includes acquiring one or more images with a camera assembly comprising one or more cameras having a field of view comprising at least a portion of a surface of a first concrete layer applied through a printing head and nozzle of a 3D concrete printer, and the 3D concrete printer comprises a controller configured to control concrete layer application, and a camera of the one or more cameras is configured to be sensitive to at least one specific wavelength range. In further aspects, the method includes transmitting the one or more images acquired to a computing device having one or more memory units configured to store the one or more images and containing instructions comprising, at least, image analysis instructions and algorithmic instructions, and a processing unit configured to utilize the instructions. Also, aspects of the method include processing the one or more images through the processing unit, based on image analysis instructions, by cropping the one or more images to remove one or more portions outside an area of interest comprising the surface portion of the first concrete layer. In additional aspects, the method includes analyzing the one or more images through the processing unit based on image analysis instructions by identifying surface area condition parameters from the one or more images, and calculating composite values from identified surface condition parameters. In continued aspects, the method includes generating an analyzed result through the processing unit based on algorithmic instructions configured to utilize the composite values, wherein the analyzed result comprises a value representing at least one of concrete setting progress, surface roughness, concrete bead quality, and interlayer bond strength. Lastly, aspects of the method include associating the analyzed result with at least time data based on when the one or more images were acquired and storing the analyzed result in one or more memory units.

In specific aspects, wherein the field of view is illuminated with ambient lighting.

In further aspects, the camera assembly further comprises an illumination source and the field of view is illuminated with light from the illumination source. In specific aspects thereof, acquiring one or more images further comprises acquiring a first image of at least a portion of the surface of the first concrete layer illuminated with ambient lighting and acquiring a second image of the first concrete layer illuminated with light from the illumination source, and standardizing pixel intensities of the one or more images comprises amending the one or more images based on identified differences in reflectivity between the first image and the second image through the processing unit based on image analysis instructions.

In certain aspects, acquiring one or more images further comprises acquiring a first image of at least a portion of the surface of the first concrete layer, within the field of view, prior to application of a second concrete layer. In specific aspects thereof, acquiring one or more images further comprises acquiring a second image of at least a portion of a surface of the first concrete layer, within the field of view, at a second time prior to application of the second concrete layer. In further aspects thereof, acquiring one or more images further comprises acquiring an additional image of the portion of the first concrete layer, within the field of view, at a third time prior to application of an second concrete layer. In aspects, acquiring one or more images further comprises acquiring a second image of a portion of a surface of a second concrete layer applied onto the portion of the surface of the first concrete layer at a second time after application of the second concrete layer, wherein the portion of the surface of the second concrete layer is disposed in vertical alignment with the portion of the surface of the first concrete layer. In an additional aspect, acquiring one or more images further comprises acquiring a first image of a first portion of the surface of the first concrete layer, prior to application of a second concrete layer upon the first portion, and acquiring a second image of a second portion of a surface of the second concrete layer, wherein the first image and second image are acquired at the same time and wherein the first portion and second portion are disposed in leading and trailing positions with respect to movement of the nozzle.

In further aspects, the camera assembly further comprises a reference member disposed within the field of view of the one or more camera and wherein standardizing pixel intensities of the one or more images comprises amending the one or more images based on equalizing the reflectivity of the reference member through the processing unit based on image analysis instructions.

In additional aspects, processing the one or more images further comprises stitching at least one image from each of the one or more cameras into one or more combined images.

In various aspects, identifying surface area condition parameters comprises identifying a first surface condition parameter value from one of the one or more images taken at a first time and identifying the second surface condition parameter value from another of the one or more images taken at a second time and calculating at least one composite value utilizing the first surface condition parameter value and second surface condition parameter value.

In certain aspects, the method further comprises transmitting the analyzed result to a user device whereby a user may observe the analyzed result.

In various aspects, the method further comprises transmitting the analyzed result to the controller, wherein the controller is configured to utilize the analyzed result to control concrete 3D printing parameters. In specific aspects thereof, the controller is also operatively connected to an adaptive batching device in fluid communication with the printing head and configured to adjust ingredients of concrete to be applied through the printing head and nozzle or to apply ingredients directly on a concrete surface, based on the analyzed result.

In aspects, processing the one or more images through the processing unit further comprises standardizing pixel intensities of the one or more images.

In additional aspects, analyzing the one or more images through the processing unit further comprises subdividing the one or more images into subregions and identifying surface condition parameters from the one or more images further comprises identifying surface condition parameters from each of the subregions. In particular aspects, analyzing the one or more images further comprises grouping identified surface condition parameters based on characteristics of the subregion and calculating composite values for each grouping.

### BRIEF DESCRIPTION OF THE DRAWINGS

The foregoing, as well as the following Detailed Description, is better understood when read in conjunction with the appended drawings. For the purposes of illustration, there is shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. Embodiments of the present invention are shown with reference to the following drawings introduced as follows:

FIG. 1 is a front elevation view of a 3D concrete printing system in the process of printing a layer of concrete demonstrating a general moment in a 3D concrete printing process);

FIG. 2A is a top plan view of a robotic arm 3D concrete printing system used to print 3D concrete printed structures;

FIG. 2B is a top plan view of a gantry 3D concrete printing system used to print 3D concrete printed structures;

FIG. 3 is a perspective view of a 3D concrete printed assembly wherein one of the layers is unfinished and annotated to identify the zone for interlayer bonding;

FIG. 4 is a front elevation view of a 3D concrete printing system in the process of printing a layer of concrete including a quality monitoring and control system according to one or more embodiments herein;

FIG. 5 is a system diagram of a 3D concrete printing quality monitoring and control system according to one or more embodiments herein;

FIGS. 6A-C are top plan views of a camera assembly of a quality monitoring and control system according to one or more embodiments herein;

FIG. 7 is an exploded elevation view of the primary components of a camera assembly of a quality monitoring and control system according to one or more embodiments herein;

FIGS. 8A-C are top plan views of a robotic arm 3D concrete printing system with a quality monitoring and control system according to one or more embodiments herein;

FIGS. 9A-C are top plan views of a gantry-type 3D concrete printing system with a quality monitoring and control system according to one or more embodiments herein;

FIG. 10 is a top plan view of a surface of a printed concrete layer showing a grid overlay exemplifying one of the numerous possible ways the computing device generates one or more surface condition parameters; and

FIGS. 11A-B are a flow chart of a method of use of a quality monitoring and control system according to one or more embodiments in a 3D concrete printing process.

### DETAILED DESCRIPTION

The following description and figures are illustrative and are not to be construed as limiting. Numerous specific details are described to provide a thorough understanding of the disclosure. In certain instances, however, well-known, or conventional details are not described to avoid obscuring the description. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

### Definitions

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way.

Alternative language and synonyms may be used for any one or more of the terms discussed herein. No special significance is to be placed upon whether a term is elaborated on or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

The phrase “3D concrete printing” herein refers to various technologies that use 3D printing techniques that extrude concrete through a nozzle in multiple layers to fabricate buildings, building components, infrastructure, and the like. This process may also be referred to by other names, including additive concrete construction, 3D printed concrete, digital fabrication with concrete, additive manufacturing for concrete, and additive construction by extrusion.

The term “concrete” herein refers to concrete, mortar, or paste. Concrete is generally a material made by curing a mixture of cement, an activator, fine aggregate, and coarse aggregate. Mortar, is generally a material similar to concrete but lacking coarse aggregate. Paste is generally a material similar to mortar but also lacking fine aggregate. Admixtures can be added to either of these materials to modify the material during the curing process, thereby concrete, mortar, or paste may also include these admixtures.

The term “cement” (and cementitious) herein refers to material that is mixed with an activator to bind together the constituent materials of concrete. This cement can be a portland or blended hydraulic cement. This cement can also be an alternative cement which is an inorganic cement that can be used as a partial or complete replacement for portland or blended hydraulic cement.

The term “activator” herein refers to the additive that is combined with cement in a process that turns the cement into the concrete binder. In portland or blended hydraulic cement, the activator is water. In alternative cements, the activator can be water or additive other than water.

The phrase “surface condition parameters” herein refers to specific characteristics of the concrete surface, such as reflectance and roughness, and are the link between image data and analyzed results.

The phrase “concrete setting progress” herein refers to the measurement of percentage of advancement towards the point of initial set of the concrete. Setting is often quantified by resistance to penetration by a needle or plunger and can be physically measured in a variety of ways.

The phrase “surface roughness” herein refers to a measure of the texture of the concrete surface. This is quantified by the vertical deviations of a concrete surface from an ideal plane. The measure of surface roughness increases as these deviations increase.

The phrase “concrete bead quality” refers to the condition of the extruded concrete surface with respect to surface defects, such as voids, tears, under extrusion, and over extrusion.

The phrase “interlayer bond strength” refers to the level of adherence or fusion between two successive layers which impacts the ability to transfer loads across the interlayer bond zone. The interlayer bond strength relates directly to the ability of the printed elements to function as a load-carrying structure. This strength is generally measured by loading specimens to failure at least seven days and most often twenty-eight days after printing.

The term “multispectral” as it applies to imaging herein refers to the capture of image data within a small number of wavelength bands across the electromagnetic spectrum, including light from frequencies beyond the visible light range.

The term “hyperspectral” as it applies to imaging herein refers to the capture of image data from many contiguous spectral bands with fine wavelength resolution. These bands cover wavelength ranges across the electromagnetic spectrum, including light from frequencies beyond the visible light range.

The phrases “machine vision” and “computer vision” may have definitions that overlap. Here, the phrase “machine vision” is defined as a systems engineering approach that encompasses the technology and methods used to extract information from an image on an automated basis, primarily in industrial automation applications. The phrase “computer vision” is defined as a computer science-based interdisciplinary approach where images are automatically extracted, analyzed, and processed through an algorithm to develop a high-level understanding of useful information. In a similar vein, the phrase “digital twin” is a computer-based model of a proposed or actual physical product, system, or process that replicates performance aspects of the proposed or actual counterpart. Using the above definitions, this quality monitoring and control system herein utilizes machine vision and/or computer vision to produce a digital twin of a portion of the 3D concrete printing process. This digital twin can be used in real time to optimize aspects of 3D concrete printing, such as concrete setting progress, surface roughness, concrete bead quality, and/or interlayer bond strength.

### 3D Concrete Printing Generally

3D concrete printing (3DCP) offers an outstanding opportunity to revolutionize the methods for constructing facilities and infrastructure. For military applications, 3DCP facilitates the development and sustainment of expedient basing needs as it provides significant improvements over traditional construction related to logistics, materials, labor, cost, training, and time to construct/repair facilities and infrastructure. For commercial applications, 3DCP increases productivity, addresses labor shortages, reduces waste, and lowers the carbon footprint of the construction industry.

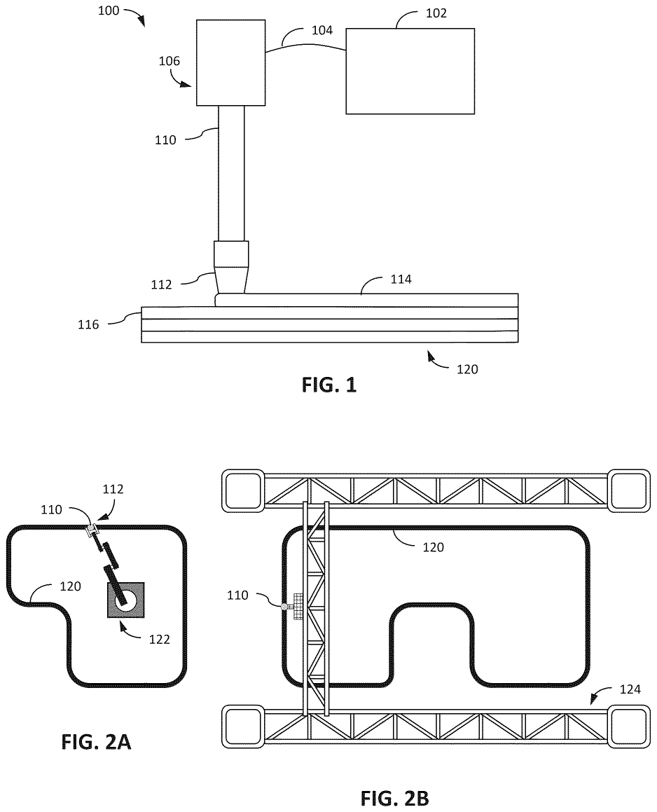

In a general 3DCP operation, a printer 100 is in fluid communication with flow machinery 106, such as storage tanks, pumps, and mixing machinery—such as an adaptive batching device 108 (FIG. 4)—to receive concrete fluid which is directed to a printing head 110 and out through a nozzle 112 having an aperture which expels a concrete bead 114 to form one or more concrete layers 116 which are built up into a printed wall 120, as shown in FIG. 1. In general, the printer 100, including the flow machinery 106, is controlled by a printer controller 102 through a communication link 104. In general, the printer controller 102 can potentially adjust parameters of the 3D concrete printer, such as the mix proportions, print speed, and flow rate in real-time. In embodiments, one or more of the potential adjustments may be carried out by portions of the printer 100 while others may be carried out by portions of the flow machinery 106. In embodiments and in FIG. 1, an adaptive batching device 108 is considered part of the flow machinery 106 (whereas, the adaptive batching device 108 is individually identified in FIG. 4). The adaptive batching device 108 can adjust the ratio and ingredients of a cementitious mix in embodiments, such as by adapting the water to cement ratio, adding admixtures, and/or adding bonding agents in various embodiments. In the embodiment shown in FIG. 4, the adaptive batching device 108 is an inline system located near the nozzle 112 of the concrete printer 100 to add materials to the concrete mix just before the concrete is deposited by the printer 100. In another embodiment, the adaptive batching device 108 could be located inline with other portions of the flow machinery 106 or in the concrete mixing system to add materials to the concrete during the mixing process. In a further embodiment, the adaptive batching device 108 could be located adjacent to the nozzle 112 to apply material to the surface of the concrete layer 116 after placement to adjust the performance of the concrete.

Currently, there are two general types of 3D concrete printers in use, as shown in FIGS. 2A and 2B. One type generally identified as a robotic arm printer has the printing head 110 and nozzle 112 affixed to, extending from, and moved by a robotic arm 122, as shown in FIG. 2A. The other type generally known as a gantry printer has the print head 110 and nozzle 112 affixed to, extending from, and directed along a gantry 124. It is anticipated that these technologies will evolve and additional types may be developed in the future.

Indeed, 3DCP is an actively emerging technology. Consequently, most development and use related to 3DCP has been in controlled settings, such as a laboratory or manufacturing facilities, where environmental conditions are generally controllable. Moreover, structures created using 3DCP are generally large and heavy and, thereby, incapable of being easily transported from manufacturing facilities to locations where they are needed or desired. Accordingly, it would be desirable to perform 3DCP on-site in field locations where the structures are intended to be located. However, environmental conditions are generally uncontrollable in these locations, which can have significant negative mechanical effects on any structure made through 3DCP. Unfortunately, the prevailing methods utilized to provide an indication of quality of structures formed through 3DCP currently generally only consider the cementitious mix and the time between layers being printed. That is, a quality structure currently created through 3DCP is currently generally regarded as that which adheres to tight controls, particularly regarding the time between printing layers.

For 3DCP to become more useful, quality control processes must be developed to allow field-based production over a wide range of ambient environmental conditions, material properties, and equipment configurations. Indeed, the industry has called for development of “in-line and automated quality control and monitoring techniques” to facilitate large scale adoption with particular focus on the interlayer bond zone, rather than just the cementitious mix and the time between layers.

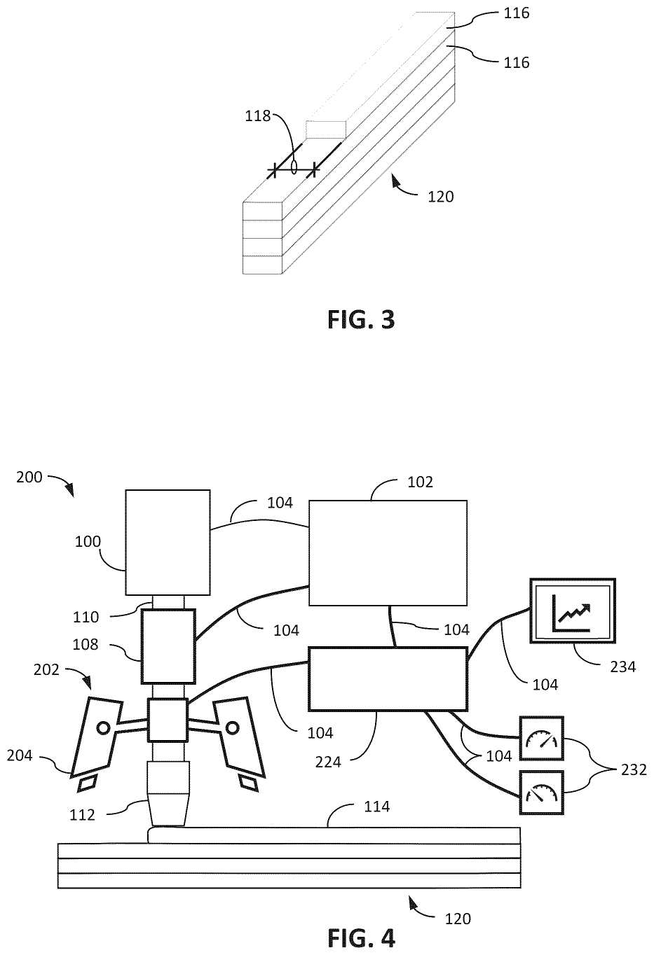

A printed concrete wall 120 is shown in FIG. 3 which shows the concrete layers 116 formed from deposited concrete beads 114. Along the top surface of each layer 116, where an additional layer 116 can be printed, is an interlayer bond zone 118. The interlayer bond zone 118 is disposed between and connects each layer 116. That is, a series of layers 116 make up the printed wall 120 with an interlayer bond zone 118 between all adjacent layers 116. Without accounting for environmental factors, 3DCP must be limited to times when environmental parameters are within tightly controlled ranges, not optimal for construction in field locations, when speed is critical, or where automation is desirable. However, this current approach will not support the scaling demands of field-based construction, such as residential construction, commercial construction, or contingent military basing in austere locations.

Indeed, quality control of information related to concrete setting progress, surface roughness, concrete bead quality, and interlayer bond strength is currently very limited to non-existent, even though poor performance related to these parameters can lead to failure of the structure. Generally, this is because such parameters are influenced by many factors, including the cementitious mix properties, mixing processes, rate of application, curing methods, plastic shrinkage, temperature, and evaporation due to wind or humidity. In a laboratory or manufacturing facility, these factors can be controlled tightly. In field locations, many of these factors, especially the environmental ones, are difficult to control and drive a need for better field-based quality control methods and information.

### System Broadly

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure.

In embodiments, a quality monitoring and control system 200, such as that of FIG. 4, is disclosed herein which generally utilizes machine vision and/or computer vision to produce a digital twin of a portion of the 3DCP process. In embodiments, this digital twin can be used in real time to optimize aspects of the 3DCP process, such as concrete setting progress, surface roughness, concrete bead quality, and/or interlayer bond strength. Accordingly, embodiments of the present 3DCP quality monitoring and control system 200 can provide better information, even in field locations where environmental factors are generally uncontrolled. Indeed, embodiments of the present quality monitoring and control system 200 facilitate simpler, more efficient and cost effective 3DCP operations through the identification and correlation of surface condition parameters 308 of concrete layer 116 surfaces upon which concrete layers 116 are about to be printed, interlayer bond zones 118, and surface condition parameters 308 of surfaces of concrete layers 116 just printed to predict, monitor and control, among other things, the remaining time for another layer to be printed, concrete setting progress, surface roughness, concrete bead quality, and the interlayer bond strength.

In embodiments, the system 200 herein is designed to account for environmental conditions, which can substantially affect the ideal time for printing another layer, concrete setting progress, surface roughness, concrete bead quality, and the interlayer bond strength. The system 200 herein is also designed, in embodiments, to provide a better method of determining the quality of a 3DCP produced structure and to allow a 3DCP process to be intelligently tailored to produce a quality 3DCP produced structure without sole reliance on tight controls to validate such quality. In embodiments, the system 200 herein is also designed to provide for an easier to learn 3DCP process which maintains a digital record of the printing process that can be used for code official acceptance, forensic analysis, process improvement, and other reasons.

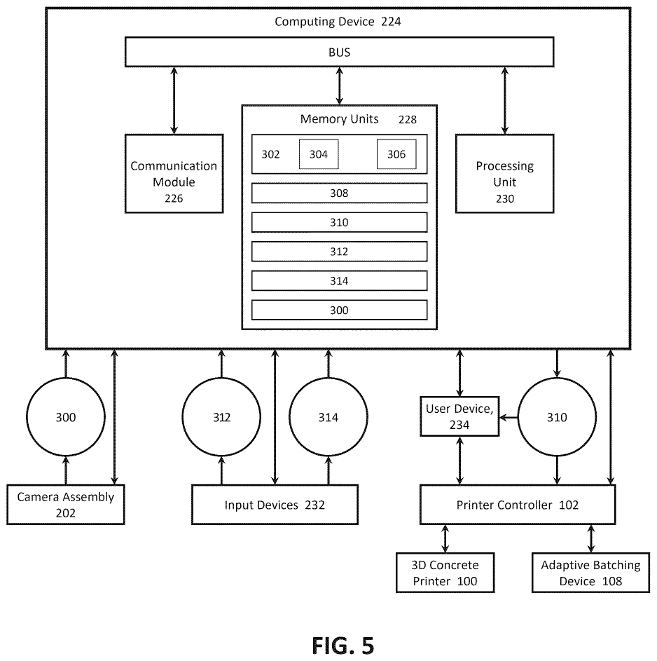

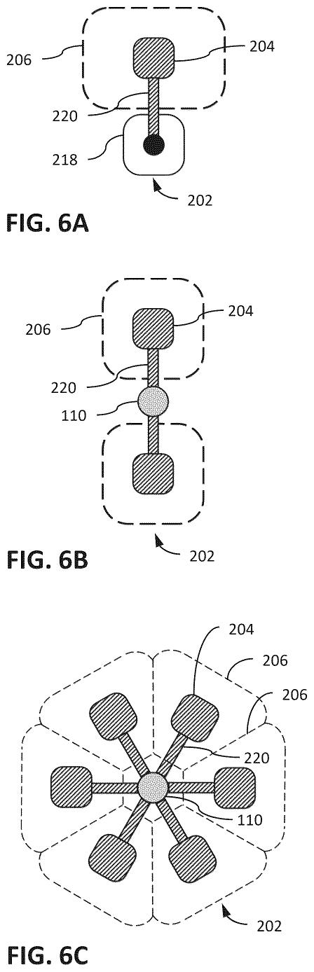

In embodiments, a quality monitoring and control system 200 is shown in FIG. 4 with components thereof included on and integrated with the 3DCP printer 100 of FIG. 1. In embodiments, the system 200 includes a camera assembly 202 having one or more cameras 204 disposed with a field of view 206 (FIG. 6) including a portion of the surface of a concrete layer 116, such as one forming a wall 120. In embodiments, each camera 204 utilized in the camera assembly 202 is sensitive to one or more specific wavelength ranges. Moreover, the system 200 includes a computing device 224 in communication, through a communication link 104, with the camera assembly 202. The cameras 204 capture image data 300 (FIG. 5) of the surface of a concrete layer 116 including the interlayer bond zone 118 and transmit the image data 300 to the computing device 224 through the link 104.

In embodiments, the computing device 224 comprises a communication module 226, one or more memory units 228, and a processing unit 230, as shown in FIG. 5. As shown in FIG. 5, the image data 300 can be stored in the one or more memory units 228 in embodiments. Indeed, the memory units 228 also store instructions 302, such as image analysis instructions 304 and algorithmic instructions 306 which are utilized by the processing unit 230 to provide surface condition parameters 308 from, at least, the image data 300 based on the image analysis instructions 304, and an analyzed result 310 from the surface condition parameters 308 based on the algorithmic instructions 306.

### Detailed Description of Particular Elements

### Camera Assembly

As provided above, the camera assembly 202 comprises at least one camera 204 in embodiments. As in FIG. 6A, the camera assembly 202, in embodiments, also includes a mount 218 configured to affix to and support the camera 204 independently from the printer 100, including the printing head 110 and nozzle 112 which might be generally movable.

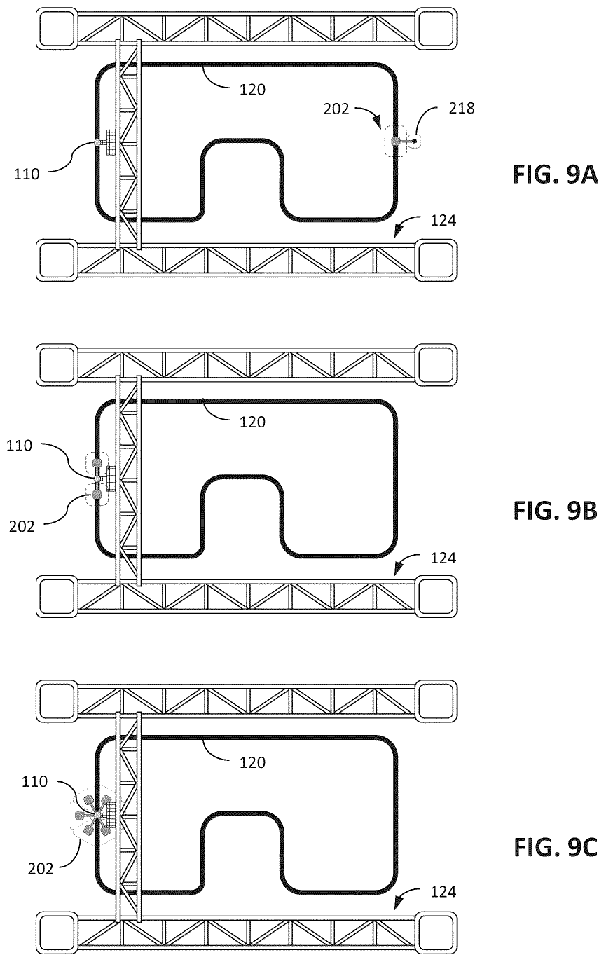

In embodiments, the mount 218 may be generally stationary in nature, as in FIGS. 8A and 9A. For example, the mount 218 may be affixed to a floor or may have portions which selectively connect to the ground to anchor the mount 218, and thereby the camera 204. In embodiments, the stationary mount 218 can provide for a fixed field of view 206 of the one or more cameras 204 affixed thereto. In such an embodiment, the stationary camera 204 collects image data 300 of the concrete layer 116 as it sets at one location until the next layer 116 is printed at that location, after which it continues collecting data on the subsequent layer 116. Image data 300 from the first pass may be utilized to create a baseline image to support image analysis on the next pass. This data may be utilized to predict concrete setting progress, surface roughness, concrete bead quality, and interlayer bond strength.

In embodiments, the camera 204 may be affixed to the mount 218 through a mounting arm 220, as in FIG. 6A. In embodiments, the mounting arm 220 can be attached to a single camera 204 so that the camera is held stationary. In other embodiments, the mounting arm 220 can affix to a camera 204 so that the position of the camera 204 is adjustable, allowing the camera 204 to be manipulated to move the field of view 206 thereof, even though the mount 218 may be stationary. In further embodiments, the camera 204 may be removably attached to the mounting arm 220 so that the camera 204 can be replaced.

In embodiments, the mount 218 may also be movable. That is, the mount 218 may be manipulable from a first location to a second location based on direct manipulation by a user, such as a user picking it up or sliding the mount 218. Indeed, in embodiments, the mount 218 may even have wheels or other structures to allow it to be moved. In at least one embodiment, the mount 218 may be motorized and controllable, similar to a RC car. Accordingly, the camera 204 and the field of view 206 may be move and manipulated by movement of the mount 218 itself. Indeed, in embodiments, the mount 218 may be movable and the mounting arm 220 may be manipulable, similar to the robotic arm 122 of the robotic arm type of concrete printer. In embodiments, one or both of the mount 218 and mounting arm 220 may be programmed to automatically move based on factors, such as a set distance for the camera 204 to be above the surface of a concrete layer 116. However, in these embodiments, the mount 218 can be generally independently manipulable relative to the printer 100 and its components so that movement of the field of view 206 can be independent of any movement of the printing head 110 and nozzle 112.

However, in embodiments, the camera assembly 202 can be affixed to portions of the printer 100, such as the printing head 110 or nozzle 112. Indeed, in FIGS. 4, 6B-C, 8B-C, and 9B-C, each of the cameras 204 of the camera assembly 202 is affixed to and disposed in a set position relative to the printing head 110 and nozzle 112 by respective mounting arms 220. Moreover, the printing head 110, and the nozzle 112, may be movable through movement of a robotic arm 122, as in FIGS. 8B and 8C, or along a gantry 124, as in FIGS. 9B and 9C. Thereby, in embodiments a camera assembly 202 affixed to a printing head 110 can also be moved by a robotic arm 122 or along a gantry 124. It should also be understood that a particular camera assembly 202 may have cameras 204 which are affixed to a mount 218 in addition to cameras 204 affixed to a printing head 110 in embodiments. Moreover, in embodiments, the cameras may be affixed to a printing head 110 in other ways than through a mounting arm 220. Accordingly, in embodiments, the camera assembly 202 may have at least one camera 204 which is stationary—relative to the printing head 110 and nozzle 112 of the printer 100—and which are movable—along with the printing head 110 or nozzle 112 of the printer 100. In additional embodiments, the camera assembly 202 may have more cameras 204 which are disposed in alternative locations to provide image data that helps monitor and control the quality of the 3DCP process. For example, additional cameras 204 may be disposed at various points along a gantry 124 to which the printer head 110 of a 3D concrete printer 100 is attached. Moreover, additional cameras 204 may be individually deployable at set lengths along the intended path of the 3DCP process. Accordingly, the image data 300 may be acquirable for intermediate time periods between the time when a layer 116 is just about to be applied and the time just after a layer 116 is applied.

Moreover, embodiments of the camera assembly 202 may have a single camera 204—such as in FIG. 6A—two cameras 204—as in FIG. 6B—or a still greater number of cameras 204—as in FIG. 6C. While the camera assembly 202 of FIG. 6A is shown having a single camera 204 affixed to a mount 218, it is to be understood that any number of cameras 204 may be affixed to the mount 218, in other embodiments. Similarly, it is also to be understood that a camera assembly 202 affixed to a printing head 110 may also have a single camera 204, though FIG. 6B shows two cameras 204 and FIG. 6C shows six cameras 204. In embodiments, the cameras 204 are disposed radially around the structure affixed to the mounting arm 220. That is, in FIG. 6B the camera assembly 202 has two cameras 204 which are disposed in leading and trailing positions relative to movement of the nozzle 112 on the printing head 110 to which the mounting arms 220 are affixed. In embodiments, the positioning of the cameras 204 in a leading and trailing position may have them disposed opposite one another relative to the nozzle 112. Thereby, the cameras 204 can acquire image data from in front and behind the nozzle 112 during a 3DCP process. Likewise, in FIG. 6C the camera assembly 202 has six cameras 204 which are each disposed radially around the printing head 110 to which the mounting arms 220 are affixed. Thereby, the camera assembly 202 can achieve a full 360-degree view with overlapping fields of view 206 so that the computing device 224 can stitch together the images to create one continuous image. Indeed, in certain embodiments, the cameras 204 are disposed at equidistant points radially around the structure affixed to the mounting arm 220 to facilitate a full 360-degree view.

In embodiments, it is foreseen that the location of one or more of the cameras 204 of the camera assembly 202 may be radially adjustable such that some or all of the cameras 204 are not opposite or equidistant from another. In at least one embodiment, the mounting arm 220 may be removably attached to a portion of the printer 100, such as the printing head 110. Thereby, different mounting arms 220 may be utilized. Also, in at least one embodiment, the mounting arm is affixed to a printer, such as the printing head 110 through a mating connection with a fastener or aperture on a sleeve or bracket that affixes to a portion of the printer 100, such as the printing head 110. In additional embodiments, the mounting arm 220 may also be of adjustable length, such as an arm 220 having telescoping segments. Moreover, it is foreseen that that the mounting arms 220 may be angularly adjustable relative to the sleeve, bracket, mount 218, printing head 110, such that the arms 220 may be folded up into a stored position when not in use and down into a deployed position when ready for use. It is also to be noted that a camera assembly 202 may have more than or less than six cameras 204, though six are shown in FIG. 6C. Each of the various embodiments of the camera assembly 202 from FIGS. 6B and 6C are shown deployed with each different type of printer 100 in FIGS. 8B-C and 9B-C.

In embodiments, the camera assembly 202 has one or more cameras 204 configured to be sensitive to at least one specific wavelength range. In embodiments, one or more of the cameras 204 of the assembly 202 may capture image data 300 from light waves, i.e., be sensitive to light, in the near infrared (NIR) and/or short-wave infrared (SWIR) ranges, such as light having an approximate wavelength range of 800 nm to 3000 nm. In certain embodiments, one or more of the cameras 204 of the assembly 202 may capture image data 300 from light waves in a portion of the visible spectrum, in addition to or in place of those within the NIR and/or SWIR spectrum. For example, at least one of the cameras 204 of the camera assembly 202 may be sensitive to light in the visible range and in the NIR/SWIR range, typically defined together as light having an approximate wavelength range of 300 nm to 3000 nm, in an embodiment. In another embodiment, at least one of the cameras 204 of the camera assembly 202 may be sensitive to light just in the visible range, such as light having an approximate wavelength range of 300 nm to 800 nm.

In at least one embodiment, at least one of the cameras 204 of the camera assembly 202 may utilize colloidal quantum dot (CQD) thin film photodiodes fabricated monolithically on silicon readout wafers. In certain embodiments, like that utilizing CQD photodiodes, the photodiode array may enable high resolution, smaller pixel pitch, broader bandwidth, low noise, and low inter-pixel crosstalk when compared with previously known and utilized cameras within a wavelength range, like the SWIR spectrum. Such an embodiment may provide the ability to make the quality monitoring and control system 200 low cost, high-volume by, for example, eliminating the prohibitively expensive hybridization process inherent to other sensors, such as those utilizing indium gallium arsenide cameras. However, in embodiments, the camera assembly 202 may indeed comprise one or more indium gallium arsenide cameras 204 or any other types of cameras 204 sensitive to light within the NIR, SWIR, and/or visible spectrum. In other embodiments, at least one of the cameras 204 may utilize digital image sensors, such as active-pixel sensors with complementary metal-oxide-semiconductor (CMOS) technology or charge-coupled device (CCD) technology.

Moreover, in embodiments, the camera assembly 202 may further include one or more additional temperature control devices which provide temperature control to the cameras to maintain consistent high quality image data and sensitivity. These additional temperature controls may be separate from or in addition to any contained within the camera 204 itself.

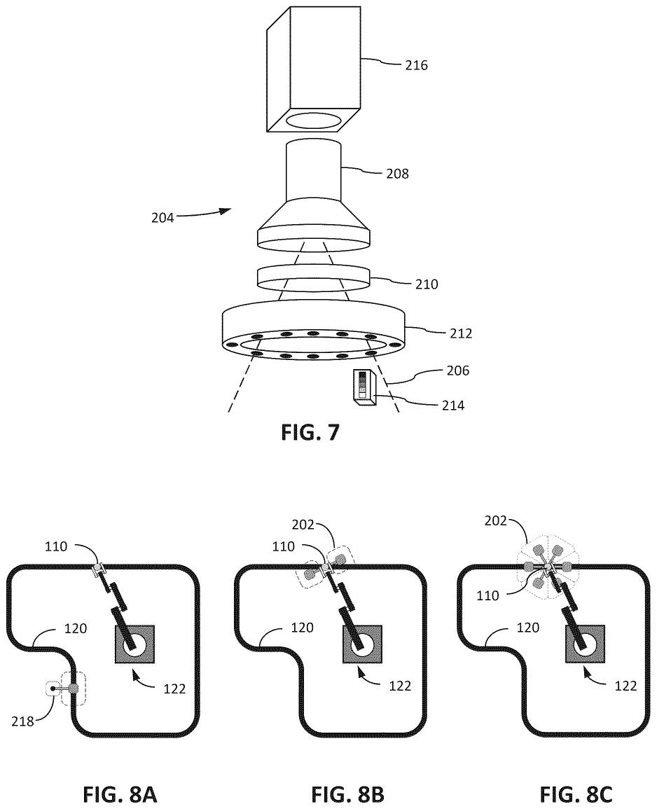

In embodiments, the cameras 204 may be area scan or line scan cameras and may operate in single-band, multispectral or hyperspectral modes to acquire image data. That is, in embodiments, each of the cameras 204 may have a specific range, which may be a subset range within 300 nm to 3000 nm, from which it acquires image data 300 (single-band). In other embodiments, each of the cameras 204 may have multiple specific ranges, all of which are subsets ranges within 300 nm to 3000 nm, from which it acquires image data 300 (multispectral). For example, one camera 204 may capture image data 300 from a first subset range of 900 nm to 1000 nm and a second subset range of 1800 nm to 2000 nm. Alternatively, the camera assembly 202 may have a single camera 204 for the first subset range and a single camera 204 for the second subset range, in embodiments. In embodiments, the subset ranges may be discreet and separate from one another. The camera 204 may be limited to a particular range, such as a subset range within the NIR/SWIR spectrum, through the use of one or more optical manipulation devices 210, such as filters or a spectrograph, in embodiments. Indeed, as shown in FIG. 7, the camera 204 thereof is positioned adjacent to an optical manipulation device 210, which may be considered part of the camera assembly 202 at least, and part of the camera 204 too, in certain embodiments. In embodiments, one or more filters may be utilized as the optical manipulation device 210 to control the bandwidths of light that reach the camera body 216, and therefore are collected as part of the image data 300. In embodiments, the optical manipulation device 210 can effectively filter out light of certain bandwidths, allowing the pass through of light within one (single-band) or more subset ranges (multispectral). That is, the camera 204 may be sensitive to light within the entire 300 nm to 3000 nm range, but the filter may only allow light within a first and/or a second subset range to pass through into the lens of the camera 204, e.g., single band or multispectral modes. In embodiments, the camera 204 includes a lens 208, as in FIG. 7, and one or more optical manipulation devices 210 disposed adjacent thereto. That is, in embodiments, the camera 204 may have one or more filters affixed thereto configured to only allow light from one or more narrow wavelength ranges into the camera lens 208 and, accordingly, to be collected in the image data 300. Narrowing of the ranges allows the image data 300 to only contain light waves which are of particular importance to generation of useful surface condition parameters 308. Indeed, the utilization of particular narrow ranges in embodiments allows for the system 200 to have operability in a variety of lighting and environmental conditions. The camera lens 208, in embodiments, is configured to focus light passing therethrough into a relevant format for the camera 204, and its internal sensors located in camera body 216.

In various embodiments, optical manipulation device 210 in camera assembly 202, such part a part of camera 204, may serve as a spectrograph to make the camera 204 operate as a line scan camera. That is, the optical manipulation device 210 may be a spectrograph, in addition to or in alternative to one or more filters. A spectrograph is an instrument utilized to split or disperse light from an object into its component wavelengths. In embodiments, the camera 204, when acting as a line-scan camera, may break light into a large number of small subset wavelength ranges (hyperspectral). The camera 204, in at least one embodiment, may be of a limited sensitivity such that it only generates image data 300 from one or a few of the many small subset wavelength ranges produced by the spectrograph. Alternatively, one or more filters may be utilized with the spectrograph output, such as by both being part of an optical manipulation device 210, so that the camera 204 only receives light form within a desired subset range and light pollution or noise from surrounding wavelengths are minimized. Accordingly, an optical manipulation device 210 may provide one, two, three, or even more specific wavelength ranges that a camera 204 may be sensitive to and may generate image data 300 therefrom.

In embodiments, the camera assembly 202 further comprises an illumination source 212, such as a light. Use of an illumination source 212 provides the ability to perform standardizing of image data 300, to be discussed later, and provides the ability to reduce, manipulate, or remove shadows that can influence image data 300. Moreover, the illumination source 212, in embodiments, can provide light within particular wavelength bands to ensure useful image data 300. Therefore, in embodiments, the assembly 202 may have one or more illumination sources 212 to provide light within the field of view 206 of a camera 204. Thereby, changes in ambient lighting may be minimized in image data 300 or may be accounted for in the processing unit 230 by comparison of image data 300 from ambient lighting conditions and image data 300 from conditions where the ambient lighting is supplemented by an illumination source 212 in embodiments. Moreover, it is to be understood, that while an illumination source 212 can help extend usefulness of the system 200, it may not be necessary to operation in various environmental conditions such as when ambient lighting is sufficient. Moreover, in embodiments, the one or more additional illumination sources 212 provide lighting control to the cameras to maintain consistent high quality image data and sensitivity. These additional illumination sources 212 may be separate from or in addition to and affixed to the camera 204 itself. These illumination sources 212 may be controlled by the computing device 224, the controller 102, or a user device 234 such that they may be varied or adapted based on particular use conditions.

In certain embodiments, the camera assembly 202 further comprises a reference member 214, which is disposed in the field of view 206 of one or more of the cameras 204. The reference member 214, which will be further discussed in following sections, provides a segment of image data 300 that can be utilized by the processing unit 230 to standardize the image data 300. For example, the reference member 214 may be expected to return particular reference image data 300 and any deviations therefrom can inform amendment that need to be made to the image data. Indeed, in one embodiment, image data 300 may require certain amendments to equalize the reflectivity of the reference member 214 to expected levels and this amendment may inform other necessary amendments to the image data 300 to standardize it before use in generating surface condition parameters 308.

### Computing Device

As specified previously, embodiments of the quality monitoring and control system 200 comprises a computing device 224, such as that shown in FIG. 5. In embodiments, the computing device is in communication through a communication link 104 with the camera assembly 202. Thereby, the computing device 224 can receive image data 300 from the camera assembly 202 and, in certain embodiments, provide certain instructions to the camera assembly 202. For example, the computing device 224 in at least one embodiment can direct movement of one or more of the cameras 204 of the camera assembly 202, particularly in embodiments where a mount 218 is motorized and configured to accept operational commands to move it. Moreover, the computing device 224 may also be in communication with the printer controller 102, through a communication link 104, to direct operation of the printer 100 or various components thereof. Indeed, in at least one embodiment, the computing device 224, as will be discussed more below, can provide an analyzed result 310 to the controller 102, which may be configured to control operation of the printer 100 based on that analyzed result 310. Indeed, in one embodiment, the computing device 224 can provide an analyzed result 310 to the controller 102 that indicates the adaptive batching device 108 should amend the concrete mixture to provide for a better interlayer bond strength and the controller 102 may provide specific amendment commands to the batching device 108 to facilitate this act. In embodiments, the adaptive batching device 108 may be configured to apply material, such as a bonding agent, to the surface of a concrete layer 116 and the controller 102 may provide specific commands to the adaptive batching device 108 to facilitate this act. In general, the printer controller 102 may be capable of adjusting parameters of the 3D concrete printer 100, such as the mix proportions, print speed, and flow rate, based on the analyzed results in real-time in embodiments. In embodiments, the computing device 224 may receive data from the printer controller 102 which identifies the location of the nozzle 112 and or operation of the printer 100 that may be utilized by the processing unit 230 to aid generation of an analyzed result 310 or preparation of a record of a printing process.

In embodiments, the computing device 224 herein comprises a communication module 226, one or more memory units 228, and a processing unit 230. In embodiments, the communication module 226 is configured to send and receive data for the computing device 224 and the one or more memory units 228 are configured to store data, including that received through the communication module 226 (like image data 300) and that generated by the processing unit 230. In embodiments, the one or more memory units 228 are also configured to store instructions 302, including image analysis instructions 304 and algorithmic instructions 306, which are utilized by the processing unit 230.

In embodiments, the processing unit 230 utilizes the image analysis instructions 304 to process and analyze the image data 300 to identify the surface condition parameters 308. For example, the processing unit 230 may utilize the image analysis instructions 304 to identify surface condition parameters 308 in image data 300. These particular surface condition parameters 308 may be stored in the one or more memory units 228 and further utilized by the processing unit 230 to determine an analyzed result 310 based on the algorithmic instructions 306, in embodiments. In embodiments, the processing unit 230 utilizes the algorithmic instructions 306 to algorithmically generate an analyzed result based, at least on, the surface condition parameters 308 and potentially on additional data, such as environmental condition data 312, concrete mixture data 314, and location data—which all may be retrieved from the one or more memory units 228 or acquired through a communications link 104 with other devices, such as input devices 232 and user devices 234, to be further discussed later.

In embodiments, the image analysis instructions 304 can direct the processing unit 230 to deal with image data from multiple cameras 204 by performing an image stitching procedure to form a single image from multiple overlapping images. Indeed, in certain embodiments like that of FIG. 6C, image stitching can provide a 360-degree image centered around a printing head 110 and nozzle 112. Moreover, in embodiments, the processing unit 230 based on the image analysis instructions 304 can rely solely on image data 300 to carry out the image stitching procedure. However, in certain embodiments, the processing unit 230 can also utilize location data which can be received from the controller 102 or camera assembly 202 to further facilitate the image stitching procedure. In embodiments, the image analysis instructions can also direct the processing unit to crop, remove, or ignore image data which may be outside an area of interest. For example, image data 300 associated with areas in the field of view 206 which are outside of the surface of a particular concrete layer 116 could be removed or ignored in a cropping procedure. Furthermore, the image analysis instructions 304 can direct the processing unit 230 to standardize image data 300 making it more precise, accurate, and/or useful. In one embodiment, the image analysis instructions 304 can direct the processing unit 230 to amend image data 300 based on the amendments required to equalize the reflectivity of a reference member 214 disposed in the field of view 206 of the camera 204, and thereby included in the image data 300. In another embodiments, the image analysis instructions 304 can direct the processing unit 230 to amend image data 300 based on the differences in reflectivity of specific areas in image data 300 associated with ambient lighting conditions and image data 300 associated with the addition of lighting from an illumination source 212. Based on the above, the image analysis instructions 304 can prepare image data for further analysis.

Indeed, the image analysis instructions 304 can direct the processing unit 230 to subdivide the image data 300 of the area of interest into smaller subregions in embodiments. For each of the subregions, the image analysis instructions 304 can direct the processing unit 230 to capture the average pixel intensity (reflectivity) and surface area calculations (roughness), e.g., surface condition parameters 308, in embodiments. Thereafter, the image analysis instructions 304 can direct the processing unit 230 to calculate composite values of these surface condition parameters 308 based on different points in time or locations in embodiments. For example, composite surface condition parameters 308 can be calculated by the processing unit 230 based on image analysis instructions 304 by utilizing the difference between the parameter just after the concrete bead 114 is applied, forming a layer 116, and just before a new layer 116 is applied. Also, composite surface condition parameters 308 can be calculated by the processing unit 230 based on image analysis instructions 304 by combining the subregions that are in similar locations or have similar characteristics, such as concrete bead 114 edge regions and/or coarser grid regions.

In embodiments, the processing unit 230 utilizes the algorithmic instructions 306 to algorithmically calculate analyzed results 310, such as values representing concrete setting progress, surface roughness, concrete bead quality, and/or interlayer bond strength, from at least the surface condition parameters 308, such as the composite surface condition parameters 308 described above. In embodiments, the algorithmic instructions 306 may direct the processing unit 230 to also utilize additional data in its algorithmic calculations, such as environmental condition data 312 and concrete mixture data 314. Thereby, the processing unit 230 takes in input data, including surface condition parameters 308 and, optionally, additional data, and generates an analyzed result 310 that can provide an indication of concrete setting progress, surface roughness, concrete bead quality, and/or interlayer bond strength which can be utilized to monitor and control a 3DCP process, providing feedback related to the acceptability of a particular concrete layer 116 to be utilized as the basis for another layer 116 and to acceptability of the structure overall produced by 3DCP. The feedback therefore, provides significantly better results and indications than the current blind methods of adherence to strict time periods, environmental conditions, and mixture compositions.

### Input Device/User Device

In embodiments, the system 200 may further comprise one or more input devices 232 and one or more user devices 234 connected through communication link 104 to the computing device 224. In embodiments, the input device can capture or receive additional data, such as environmental condition data 312 and/or concrete mixture data 314 which can be transmitted to the computing device 224 to be saved in the one or more memory units 228 and/or utilized by the processing unit 230 to determine the analyzed result 310, along with the surface condition parameters 308, based on calculations from algorithmic instructions 306. In embodiments, the input devices 232 may be sensors designed to determine one or more of temperature, sun exposure, wind speed/direction, humidity, dust, or other potential factors that affect concrete setting, for environmental condition data 312. In further embodiments, the input devices 232 may be sensors designed to determine one or more of viscosity, rheology, temperature, weight, moisture, application pressure (pressure of the concrete bead 114 exiting the nozzle 112), a ratio of water and cement, and resistivity, or other characteristics regarding the concrete mixture, for concrete mixture data 314. In alternative embodiments, the printer 100 itself may have sensors to determine and generate environmental condition data 312 and concrete mixture data 314. In certain embodiments, the input device 232, and/or even the printer, may include one or more user interfaces to accept user input for various portions of the data. That is, in embodiments, the user may be able to input a value in an input device 232, or printer 100, to replace, adjust, or provide one or more of the data points that make up the environmental condition data 312 and concrete mixture data 314.

However, in embodiments, the system 200 may utilize a user device 234 to receive and review an analyzed result 310. That is, in an embodiment, the analyzed result 310 may be transmitted from the computing device 224 to the user device 234 and displayed to a user. Additionally, the user device 234 may, in embodiments, accept user input which, through a communication link 104 with the computing device 224, can be utilized to set or edit data, such as environmental condition data 312 and concrete mixture data 314, or provide operation instructions for the controller 102. That is, a user may, in embodiments, instruct the controller 102 on operation of the 3DCP process by passing commands from the user device 234 to the controller 102 through the computing device 224. However, in instances, the user device 234 may also connect directly to the controller 102 through a communication link 104.

In embodiments, the communication link 104 herein connecting various components may be either wired or wireless, as beneficial or desired.

### Method of Use

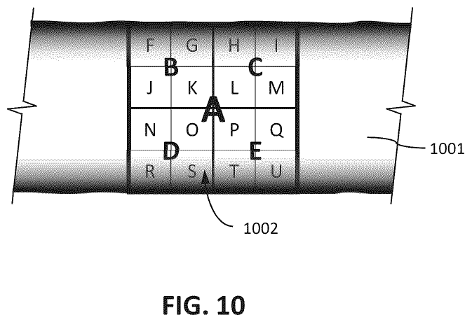

In particular embodiments, the instructions 302 stored in and utilized by the computing device 224 include or are based on an algorithm which directs the processing unit in one or both of how to generate the surface condition parameters, e.g., the image analysis instructions 304, and how to produce an analyzed result, the algorithmic instructions 306. For example, the image analysis instructions 304 may direct the processing unit 230 to perform various image analysis tasks on image data 300 associated with a particular wavelength, which may form a part of the image data 300, to generate a profile of average gray values of individual subregions 1002 along a distance in a specified direction on a surface 1001 of a concrete layer 116 (see FIG. 10) and the instructions 302 may utilize the data from that profile or a number of profiles over a period of time to generate surface condition parameters 308 and/or produce an analyzed result 310.

In certain embodiments, the algorithmic instructions 306 cause the processing unit 230 to correlate the surface condition parameters 308 to a particular calculated analyzed result 310, such as progress towards setting of the concrete, surface roughness, concrete bead quality, and interlayer bond strength, based on an algorithm.

In embodiments, the concrete setting progress can provide a guide to predicting the remaining time or period for an additional concrete layer 116 to be printed on the previous layer 116 through 3DCP. In further embodiments, the algorithmic instructions 306 cause the processing unit 230 to correlate the surface condition parameters 308 to surface roughness. In embodiments, the surface roughness can provide a guide to predicting interlayer bond strength along with whether the surface roughness will be within acceptable parameters.

In similar embodiments, the algorithmic instructions 306 cause the processing unit 230 to correlate the surface condition parameters 308 to concrete bead quality. In embodiments, concrete bead quality can provide a guide to predicting mix design and print process limits as well as interlayer bond strength along with whether the bead quality will be within acceptable parameters.

In other embodiments, the algorithmic instructions 306 cause the processing unit 230 to correlate the surface condition parameters 308 to an interlayer bond strength based on an algorithm to produce an interlayer bond strength prediction. The interlayer bond strength prediction can provide a measurement and/or guide to identifying whether the interlayer bond strength will be within acceptable parameters.

In embodiments, one or more of the image analysis instructions 304 and algorithmic instructions 306 may utilize additional data, beyond just the image data 300, to determine the surface condition parameters 308 and/or the analyzed result 310. Indeed, in embodiments, the instructions 302 may instruct the processing unit 230 to consider environmental condition data 312 and/or concrete mixture data 314 to produce one or both surface condition parameters 308 and analyzed results 310. These various data points are stored in the memory units 228 of the computing device 224, in embodiments. Moreover, in embodiments, one or more of the environmental condition data 312 and concrete mixture data 314 may be adjusted or replaced based on additional data received from the input devices 232. In certain embodiments, the instructions 302 may cause the processing unit 230 to produce new analyzed results 310 and surface condition parameters 308 each time one or more of the stored data points is updated. Therefore, the computing device 224 may operate in real time. Historical values for a portion or all the data stored in the computing device 224, including that generated or produced thereby may also be stored in the memory units 228 in embodiments. Indeed, in certain embodiments, the processing unit 230 may produce graphical representations of the historical values, such as heat maps or plots over time, to be sent to and displayed by a user device 234. In embodiments, these historical values may form a digital record of the 3DCP process and may be accessible at stages to verify the acceptability of a structure produced by a specific 3DCP process.

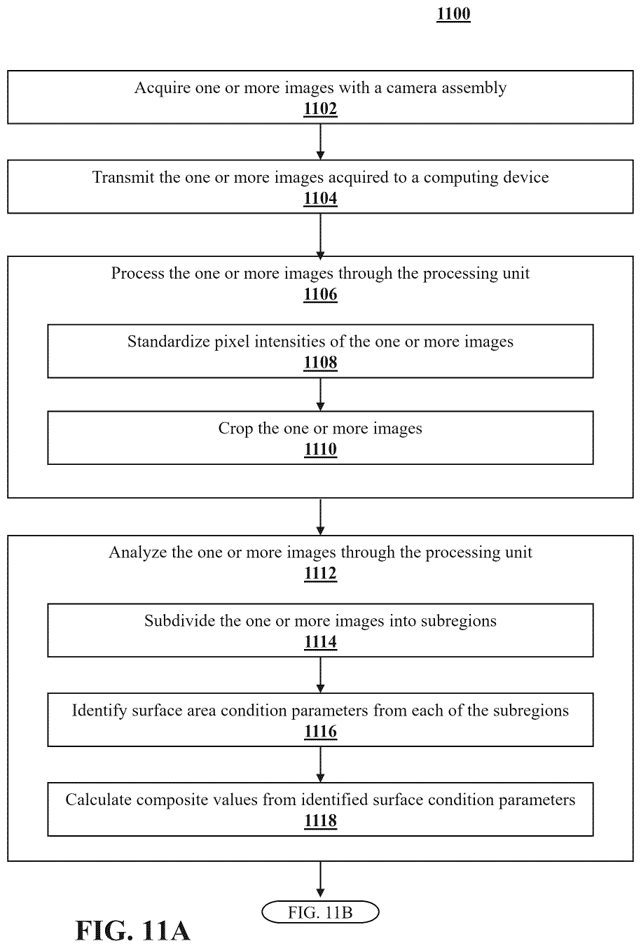

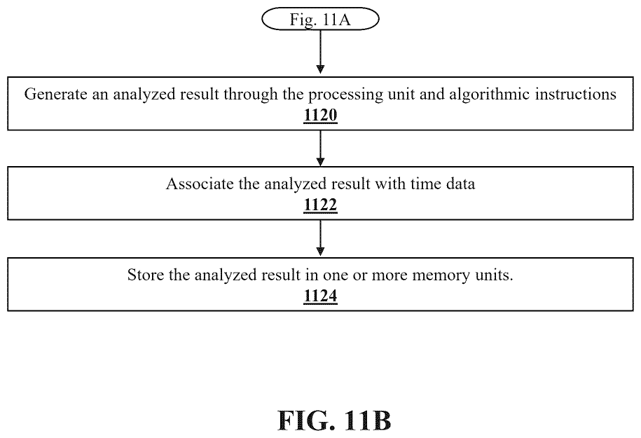

In at least one method of use, the system 200 may be utilized to generate an analyzed result 310, such as values representative of concrete setting progress, surface roughness, concrete bead quality, and interlayer bond strength, based on image data 300 in a method 1100, such as that shown in FIG. 11. In embodiments, method 1100 comprises acquiring 1102 one or more images (image data 300) with a camera assembly comprising one or more cameras having a field of view comprising at least a portion of a surface of a first concrete layer applied through a printing head and nozzle of a 3D concrete printer, wherein the 3D concrete printer comprises a controller configured to control concrete layer application, and wherein a camera of the one or more cameras is configured to be sensitive to at least one specific wavelength range. In embodiments, the method 1100 further comprises transmitting the one or more images 1104 acquired to a computing device having one or more memory units configured to store the one or more images (image data 300) and containing instructions comprising, at least, image analysis instructions and algorithmic instructions, and a processing unit configured to utilize the instructions. The method 1100 continues, in embodiments, with processing the one or more images 1106 through the processing unit, based on image analysis instructions, by standardizing pixel intensities of the one or more images (image data 300) 1108 and cropping the one or more images (image data 300) to remove one or more portions outside an area of interest 1110 comprising the portion of the surface of the concrete layer. Thereafter, in embodiments, the method 1100 further comprises analyzing the one or more images (image data 300) 1112 through the processing unit based on image analysis instructions by subdividing the one or more images into subregions 1114, identifying surface area condition parameters from each of the subregions 1116, and calculating composite values from identified surface condition parameters 1118. Furthermore, an embodiment of the method 1100 further comprises generating an analyzed result 1120 through the processing unit based on algorithmic instructions configured to utilize the composite values, wherein the analyzed result comprises a value representing at least one of concrete setting progress, surface roughness, concrete bead quality, and interlayer bond strength. In additional embodiments, the method 1100 further comprises associating the analyzed result with at least time data based on when the one or more images were acquired 1122 and storing the analyzed result in one or more memory units 1124.

In certain embodiments, acquiring one or more images 1102 further comprises acquiring a first image of at least a portion of the surface of the first concrete layer illuminated with ambient lighting and acquiring a second image of the first concrete layer illuminated with light from an illumination source that is part of the camera assembly, and wherein standardizing pixel intensities of the one or more images 1108 comprises amending the one or more images based on identified differences in reflectivity between the first image and the second image through the processing unit based on image analysis instructions.

In at least one embodiment, acquiring one or more images 1102 further comprises acquiring a first image of at least a portion of the surface of the first concrete layer, within the field of view, prior to application of a second concrete layer. In an additional embodiment therefrom, acquiring one or more images 1102 further comprises acquiring a second image of at least a portion of a surface of the second concrete layer, within the field of view, after the application of the second concrete layer. In a still further embodiment therefrom, acquiring one or more images 1102 further comprises acquiring additional images of at least a portion of the second concrete layer, within the field of view, prior to application of an additional concrete layer.

In certain embodiments, standardizing pixel intensities of the one or more images 1108 comprises amending the one or more images based on equalizing reflectivity of a reference member, disposed in the field of view of one of the cameras of the camera assembly, through the processing unit based on image analysis instructions.

In additional embodiments, processing the one or more images 1106 further comprises stitching at least one image from each of the one or more cameras into a single combined image.

In further embodiments, identifying surface area condition parameters from each of the subregions 1116 comprises identifying a first surface condition parameter value from one of the one or more images taken at a first time and identifying a second surface condition parameter value from another of the one or more images taken at a second time and calculating at least one composite value utilizing the first surface condition parameter value and second surface condition parameter value.

In certain embodiments, analyzing the one or more images 1112 further comprises grouping identified surface condition parameters based on characteristics of one of the subregions and calculating composite values for each grouping. In other embodiments, the method 1100 further comprises transmitting the analyzed result to a user device whereby a user may observe the analyzed result. In similar embodiment, the method 1100 further comprises transmitting the analyzed result to the controller, wherein the controller is configured to utilize the analyzed result to control concrete printing. In one particular embodiment, the controller is also operatively connected to an adaptive batching device in fluid communication with the printing head and configured to adjust ingredients of concrete to be applied through the printing head and nozzle based on the analyzed result or through applying ingredients, such as a bonding agent, directly on the concrete bead and/or surface of a concrete layer.

### Further Understandings

In various embodiments, data is sent between various portions of the system, such as environmental condition data 312 being sent to the computing device 224 from an input device 232 and image data 300 being sent to the computing device 224 from the camera assembly 202. In embodiments, the transmission and receipt of data between various portions of the system are conducted through a network. In some instances, the network links are identified as communication links 104. The network may include any combination of wired or wireless networks, such as a Wi-Fi router connected to the internet, or a cellular tower connected to the internet. For example, various portions of the system may be connected through USB cables or ethernet cables. Indeed, the cameras 204 attached to the printing head 110 may be connected to the computing device 232 through fiber optic cables in one example. However, additional cameras 204 which might be independently set up and utilized might be connected to the computing device 232 through a wireless network.

Moreover, in embodiments, the computing device 224 may comprise a backend server to which various client devices, such as a user device 234 or controller 102 or other computing devices 224, may connect to receive data and/or pass instructions. For example, an analyzed result 310 may be sent to a user device 234 for display by being stored on a server, which forms part of the network, from which the displaying user may request it. Additionally, a server as part of a network may provide storage for historical data.

In general, the network through which various portions of the system may communicate, may be a cellular network, a broadband network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, UDP, HTTP, DNS, FTP, UPnP, NSF, ISDN, PDH, RS-232, SDH, SONET, etc. Indeed, communications can be achieved via, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), or any broadband network, and further enabled with technologies such as, by way of example, Global System for Mobile Communications (GSM), Personal Communications Service (PCS), Bluetooth, WiFi, Fixed Wireless Data, 2G, 2.5G, 3G (e.g., WCDMA/UMTS based 3G networks), 4G, IMT-Advanced, pre-4G, LTE Advanced, 5G, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, HSPA+, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks, broadband networks, or messaging protocols.

The network can be any collection of distinct networks operating wholly or partially in conjunction to provide connectivity to the various devices and/or various portions of the system and may appear as one or more networks to the various portions and/or devices. In one embodiment, communications to and from the various portions and/or devices can be achieved by, an open network, such as the Internet, or a private network, broadband network, such as an intranet and/or the extranet. In one embodiment, communications can be achieved by a secure communications protocol, such as secure sockets layer (SSL), or transport layer security (TLS).

As will be appreciated by one skilled in the art, aspects of the technology described herein may be embodied as a system, method, or computer program product. Accordingly, aspects of the technology may take the form of an entirely hardware embodiment, an entirely software embodiment (including firmware, resident software, micro-code, etc.) or an embodiment combining software and hardware aspects that may all generally be referred to herein as a “circuit,” “module,” “unit,” or “system.” Furthermore, aspects of the technology may take the form of a computer program product embodied in one or more computer readable medium(s) having computer readable program code embodied thereon. Herein, references to a program or code may also encompass and be referred to as “instructions,” an “algorithm,” or even “algorithmic instructions” of the present embodiments of the system.

Any combination of one or more computer readable medium(s), e.g., memory units and/or a memory storage device identified in embodiments of the present system, may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code, e.g., instructions and algorithms, embodied on a computer readable medium may be transmitted using any appropriate medium, including but not limited to wireless, wireline, optical fiber cable, RF, etc., or any suitable combination of the foregoing.

Instructions, algorithms, and other computer program code for carrying out operations for aspects of the technology described herein may be written in any combination of one or more programming languages, including object oriented and/or procedural programming languages. Programming languages may include, but are not limited to: Ruby®, JavaScript®, Java®, Python®, PHP, C, C++, C #, Objective-C®, Go®, Scala®, Swift®, Kotlin®, OCaml®, G-code, M-code, or the like. The program code, instructions, and algorithms may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, described previously.

These computer program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/acts specified in the descriptions of the system herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the descriptions of the system herein.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions/acts specified in the descriptions of the system herein.

Any dimensions expressed or implied in the drawings and these descriptions are provided for exemplary purposes. Thus, not all embodiments within the scope of the drawings and these descriptions are made according to such exemplary dimensions. The drawings are not necessarily made to scale. Thus, not all embodiments within the scope of the drawings and these descriptions are made according to the apparent scale of the drawings regarding relative dimensions in the drawings. However, for each drawing, at least one embodiment is made according to the apparent relative scale of the drawing.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive subject matter. As used herein, the term “and/or” includes all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that when an element or layer is referred to as being “on” another element or layer, the element or layer can be directly on another element or layer, or intervening elements or layers may also be present. In contrast, when an element is referred to as being “directly on” another element or layer, there are no intervening elements or layers present.

Spatially relative terms, such as “below,” “beneath,” “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. Throughout the specification, like reference numerals in the drawings denote like elements.

Embodiments of the inventive subject matter are described herein with reference to plan and perspective illustrations that are schematic or diagrammatic illustrations of idealized embodiments of the inventive subject matter. As such, variations from the shapes of the illustrations as a result, for example, of manufacturing techniques and/or tolerances, are to be expected. Thus, the inventive subject matter should not be construed as limited to the shapes of objects illustrated herein, but should include deviations in shapes that result, for example, from manufacturing. Thus, the objects illustrated in the figures are schematic in nature and their shapes are not intended to illustrate the actual shape of a region of a device and are not intended to limit the scope of the inventive subject matter.

The terminology used herein is for the purpose of describing embodiments only and is not intended to be limiting of the present inventive subject matter. As used herein, the singular forms “a,” “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present inventive subject matter belongs. It will be further understood that terms used herein should be interpreted as having a meaning that is consistent with their meaning in the context of this specification and the relevant art and will not be interpreted in an idealized or overly formal sense unless expressly so defined herein. The term “plurality” is used herein to refer to two or more of the referenced items. Although any methods, devices, and materials similar or equivalent to those described herein can be used in the practice or testing of the presently disclosed subject matter, representative methods, devices, and materials are now described.

In the drawings and specification, there have been disclosed typical preferred embodiments of the inventive subject matter and, although specific terms are employed, they are used in a generic and descriptive sense only and not for purposes of limitation, the scope of the inventive subject matter being set forth in the following claims.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A 3D concrete printing quality monitoring and control system configured for use with a 3D concrete printer having a printing head terminating in a nozzle with an aperture configured to direct application of concrete, the quality monitoring and control system comprising:
a camera assembly comprising one or more cameras configured to be sensitive to at least one specific wavelength range and having a field of view including at least a portion of a concrete layer surface, wherein the one or more cameras are configured to capture image data from the concrete layer surface, and
wherein the field of view includes (i) a first portion of a surface of a first concrete layer prior to application of a second concrete layer upon the first portion, and (ii) a second portion of a surface of the second concrete layer after application of the second concrete layer, and
wherein the first portion and the second portion are disposed in leading and trailing positions with respect to movement of the nozzle; and
a computing device in communication with the camera assembly, wherein the computing device comprises
a communication module configured to receive the image data transmitted by the camera assembly,
one or more memory units configured to store image data and containing instructions comprising, at least, image analysis instructions and algorithmic instructions, and
a processing unit configured to utilize the image analysis instructions to generate one or more surface condition parameters from stored image data and to utilize the algorithmic instructions to generate an analyzed result based at least on the one or more surface condition parameters.

2. The quality monitoring and control system of claim 1, wherein the camera assembly comprises at least one camera affixed to the printing head of the 3D concrete printer and configured to capture image data from the concrete layer surface adjacent to the nozzle to include at least one of the first portion and the second portion.

3. The quality monitoring and control system of claim 2, wherein the camera assembly comprises a plurality of cameras affixed to the printing head, the plurality of cameras including (i) two cameras disposed on opposed sides of the nozzle, or (ii) three or more cameras disposed radially around the printing head to provide fields of view that include the leading and trailing positions.

4. The quality monitoring and control system of claim 1, wherein the camera assembly further comprises an illumination source, and wherein the processing unit is configured to standardize the image data, prior to generating the one or more surface condition parameters, by comparing (i) first image data collected when the illumination source is inactive and (ii) second image data collected when the illumination source is active.

5. The quality monitoring and control system of claim 1, further comprising a reference member disposed within the field of view of the camera assembly wherein the processing unit is configured to standardize the image data, prior to generating the one or more surface condition parameters, based on image data corresponding to the reference member.

6. The quality monitoring and control system of claim 1, wherein the analyzed result comprises at least one value indicative of concrete setting progress or interlayer bond strength.

7. The quality monitoring and control system of claim 1, further comprising an input device comprising one or more sensors configured to sense one or more environmental condition data of temperature, sun exposure, wind, humidity, and dust and configured to generate additional data,
wherein the communication module is further configured to receive the additional data transmitted from the input device,
wherein the one or more memory units are further configured to store the additional data, and
wherein the processing unit is configured to utilize the algorithmic instructions to generate an analyzed result based at least in part on the additional data and the one or more surface condition parameters.

8. The quality monitoring and control system of claim 1, further comprising an input device comprising one or more sensors configured to sense one or more concrete mixture data of viscosity, rheology, temperature, weight, moisture, and resistivity of the concrete, and configured to generate additional data,
wherein the communication module is further configured to receive the additional data transmitted from the input device,
wherein the one or more memory units are further configured to store the additional data, and
wherein the processing unit is configured to utilize the algorithmic instructions to generate an analyzed result based at least in part on the additional data and the one or more surface condition parameters.

9. The quality monitoring and control system of claim 1, wherein the camera assembly comprises at least one camera having an image sensor that comprises (i) colloidal quantum dot thin film photodiodes fabricated monolithically on silicon readout wafers or (ii) an indium gallium arsenide sensor.

10. The quality monitoring and control system of claim 1, wherein the at least one specific wavelength range comprises a first subset range narrower than and within (i) a range of 800 nm to 3000 nm or (ii) a range of 300 nm to 3000 nm.

11. The quality monitoring and control system of claim 10, wherein the at least one specific wavelength range further comprises a second subset range within the range of 300 nm to 3000 nm and not overlapping with the first subset range.

12. The quality monitoring and control system of claim 1, wherein the analyzed result is transmitted to a controller operatively connected to the 3D concrete printer,
wherein the controller is operatively connected to an adaptive batching device in fluid communication with the printing head, and
wherein, based on the analyzed result, the adaptive batching device is configured to adjust ingredients of concrete to be applied through the nozzle or to apply one or more ingredients directly to the concrete layer surface.

13. The quality monitoring and control system of claim 1, wherein the controller is configured to transmit location data indicative of a position of the nozzle to the computing device, and wherein the computing device is configured to associate the location data with the image data to determine whether the image data corresponds to the first portion disposed in the leading position or the second portion disposed in the trailing position with respect to movement of the nozzle, and to store the location data in the one or more memory units.

14. The quality monitoring and control system of claim 1, wherein the one or more memory units are further configured to store additional data comprising at least one of environmental condition data and concrete mixture data.

15. The quality monitoring and control system of claim 14, wherein the processing unit is configured to generate the analyzed result based at least in part on the additional data and the one or more surface condition parameters.
